(19) United States
(12) Patent Application Publication
(10) Pub. No.: US 2010/0174079 A1
(43) Pub. Date: Jul. 8, 2010

(54) PROCESS FOR PRODUCTION OF OPTICALLY ACTIVE PHOSPHOROUS COMPOUND

(75) Inventors: Li-Biao Han, Ibaraki (JP); Qing Xu, Ibaraki (JP)

Correspondence Address: EDWARDS ANGELL PALMER & DODGE LLP, P.O. BOX 55874, BOSTON, MA, 02205, US

(73) Assignee: National Institute of Advanced Industrial Science Technology, Chiyoda-ku ,Tokyo (JP)

(21) Appl. No.: 12/441,229

(22) PCT Filed: Aug. 20, 2007
(86) PCT No.: PCT/JP2007/066092

§ 371 Date: Mar. 13, 2009

(30) Foreign Application Priority Data
Sep. 13, 2006 (JP) 2006-248707

(51) Int. Cl. C07F 9/58; C07F 9/53; C07F 9/6553

(52) U.S. Cl. 546/21; 568/14; 568/15; 549/6

(57) ABSTRACT

Disclosed is a process for producing an optically active phosphorus compound having an R- or S-type absolute configuration on phosphorus in a simple manner and at high efficiency, while avoiding racemization.

An optically active phosphorus compound having an R- or S-type absolute configuration on phosphorus represented by the general formula (III) can be produced by reacting an optically active phosphorus compound having an R- or S-type absolute configuration on phosphorus represented by the general formula (I) with a metal compound represented by the general formula (II) and water. (I) wherein R¹ represents a hydrogen atom, analkyl group, a cycloalkyl group, an aralkyl group or an aryl group; and R² represents a hydrogen, an alkyl group, a cycloalkyl group, an aryl group, an aralkyl group, alkenyl group, an alkoxy group, an aryloxy group, a heterocyclic ring residue or a silyl-containing group. R³M (II) wherein R³ is the same as R²; and M represents a lithium or magnesium halide MgX (X═Cl, Br or I). (III) wherein R² and R³ are as defined above.

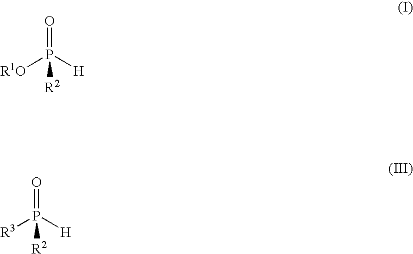

### TECHNICAL FIELD

The present invention relates to processes for producing an optically active phosphine oxide having an R- or S-type absolute configuration on phosphorus.

### BACKGROUND ART

Optically active phosphine oxides having chirality on phosphorus are substances that are widely useful as the ligands of various asymmetric catalysts, or as synthesis intermediates thereof. For example, a trisubstituted phosphine oxide is easily converted to an optically active phosphine by stereospecific reduction (Non-Patent Document 1).

Such optically active phosphines are being widely used in the field of synthetic chemistry or chemical industry, as the ligands of various asymmetric catalysts.

Meanwhile, optically active disubstituted phosphines oxides are recently attracting attention as ligands that are stable against air. In other words, when these compounds are used as ligands, a catalytic reaction which cannot be generally carried out in the presence of air, proceeds even in the presence of air. Therefore, it is possible to simplify the reaction process, and significant convenience is brought to the industrial processes (Non-Patent Document 2).

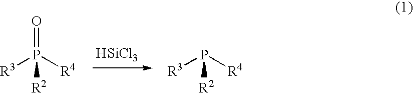

There is already known a method of synthesizing the above-mentioned optically active phosphine oxide having chirality on phosphorus, where a representative method may be exemplified by production based on the optical resolution of racemates, but this method requires complicated experimental operations (Non-Patent Document 3).

On the other hand, according to a known reaction, a hydrogen phosphinic acid ester reacted with a Grignard reagent or an organolithium compound to yield a disubstituted phosphine oxide which is a racemic form having the alkoxy group substituted with a carbonic substituent. However, when an investigation was made on the reaction between an optically active hydrogen phosphinic acid ester and a Grignard reagent or an organolithium compound by using the same technique, only completely racemized products could be obtained (Non-Patent Document 4).

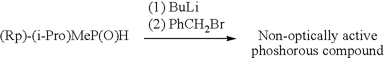

Non-Patent Document 1: L. D. Quint, A Guide to Organophosphorus Chemistry, Wiley Interscience, New York, 2000, pp. 272-306

Non-Patent Document 2: Angew. Chem. Int. Ed. 2004, 43, 5883-5886

Non-Patent Document 3: Chem. Rev. 2004, 104, 2239-2258

Non-Patent Document 4: J. Am. Chem. Soc. 1970, 92, 5275-5276

### DISCLOSURE OF THE INVENTION

### Problems to be Solved by the Invention

It is an object of the present invention to provide processes for conveniently and efficiently producing an optically active phosphorus compound having a R- or S-type absolute configuration on phosphorus, while avoiding racemization.

### Means for Solving the Problems

The inventors of the present invention conducted an investigation on the reaction between an optically active phosphinic acid ester and an organolithium or a Grignard reagent, and as a result, they found a method for stereospecific conversion of optically active phosphinic acid esters, in which when the reaction is carried out under particular conditions, racemization of the configuration on phosphorus can be avoided. Thus, the inventors finally completed the present invention based on this finding.

Specifically, according to this application, the following inventions are provided.

<1> A process for producing an optically active phosphorus compound having an R- or S-type absolute configuration on phosphorus, represented by the general formula (III):

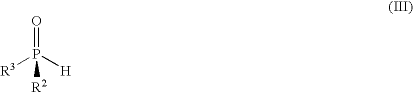

wherein R² represents hydrogen, an alkyl group, a cycloalkyl group, an aryl group, an aralkyl group, an alkenyl group, an alkoxy group, an aryloxy group, a heterocyclic ring residue or a silyl-containing group; and R³ represents the same substituents as those for R²;

the process including reacting an optically active phosphorus compound having an R- or S-type absolute configuration on phosphorus, represented by the general formula (I):

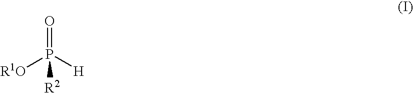

wherein R¹ represents a hydrogen atom, an alkyl group, a cycloalkyl group, an aryl group or an aralkyl group; and R² has the same meaning as defined above;

with water and a metal compound represented by the general formula (II):

R³M (II)

wherein R³ has the same meaning as defined above; and M represents lithium or magnesium halide, MgX (X═Cl, Br or I).

<2> A process for producing an optically active phosphorus compound having an R- or S-type absolute configuration on phosphorus, represented by the general formula (V):

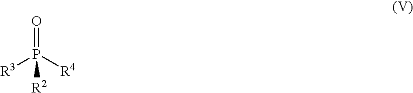

wherein R² and R³ have the same meanings as defined above; and R⁴ represents the same substituents as those for R³;

the process including reacting an optically active phosphorus compound having an R- or S-type absolute configuration on phosphorus, represented by the general formula (I):

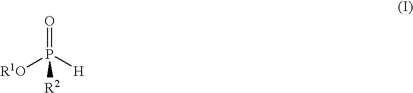

wherein R¹ and R² have the same meanings as defined above;

with a metal compound represented by the general formula (II):

R³M (II)

wherein R³ and M have the same meanings as defined above;

and a halide represented by the general formula (IV):

R⁴X (IV)

wherein R⁴ has the same meaning as defined above; and X represents halogen.

<3> The process for producing an optically active phosphorus compound having an R- or S-type absolute configuration on phosphorus according to <1> or <2>, wherein the optically active compound represented by the general formula (I) is (Rp)-menthylphenyl phosphinate.

<4> The process for producing an optically active phosphorus compound having an R- or S-type absolute configuration on phosphorus according to any one of <1> to <3>, wherein the reaction temperature is in the range of 0° C. to −100° C.

### Effects of the Invention

According to the processes of the present invention, optically active phosphorus compounds having an R- or S-type absolute configuration on phosphorus can be produced conveniently and efficiently, while avoiding racemization.

### BEST MODE FOR CARRYING OUT THE INVENTION

The synthesis reaction of the present invention may be diagrammatically represented by the following scheme.

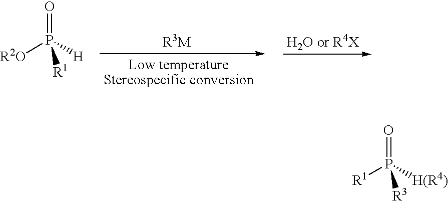

In the present invention, an optically active phosphorus compound having a R- or S-type absolute configuration on phosphorus, represented by the following general formula (I) is used as a reaction raw material:

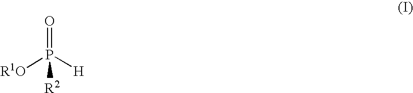

wherein R¹ represents a hydrogen atom, an alkyl group, a cycloalkyl group, an aryl group or an aralkyl group or an aryl group; and R² represents hydrogen, an alkyl group, a cycloalkyl group, an aryl group, an aralkyl group, an alkenyl group, an alkoxy group, an aryloxy group, a heterocyclic ring residue or a silyl-containing group.

The number of carbon atoms of the aforementioned alkyl group is 1 to 18, and preferably 1 to 10. Specific examples thereof include methyl, ethyl, propyl, hexyl, decyl and the like.

The number of carbon atoms of the aforementioned cycloalkyl group is 5 to 18, and preferably 5 to 10. Specific examples thereof include cyclohexyl, cyclooctyl, cyclododecyl and the like.

The number of carbon atoms of the aforementioned aryl group is 6 to 14, and preferably 6 to 10. Specific examples thereof include phenyl, naphthyl, and substituents thereof (tolyl, naphthyl, benzylphenyl, and the like).

The number of carbon atoms of the aforementioned aralkyl group is 7 to 13, and preferably 7 to 9. Specific examples thereof include benzyl, phenethyl, phenylbenzyl, naphthylmethyl and the like.

The number of carbon atoms of the aforementioned alkenyl group is 2 to 18, and preferably 2 to 10. Specific examples thereof include vinyl, 3-butenyl and the like.

The number of carbon atoms of the aforementioned alkoxy group is 1 to 8, and preferably 1 to 4. Specific examples thereof include methoxy, ethoxy, butoxy and the like.

The number of carbon atoms of the aforementioned aryloxy group is 6 to 14, and preferably 6 to 10. Specific examples thereof include phenoxy, naphthyloxy and the like.

The heteroaryl group is a group derived from a cyclic compound of various types containing heteroatoms (oxygen, nitrogen, sulfur and the like), and the number of atoms contained therein is 4 to 12, and preferably 4 to 8. Specific examples thereof include a thienyl group, a furyl group, a pyridyl group, a pyrrolyl group and the like.

The aforementioned silicon-containing group includes those substituted with an alkyl group, an aryl group, an aralkyl group or an alkoxy group. Specific examples thereof include trimethylsilyl, triethylsilyl, triphenylsilyl, phenyldimethylsilyl, trimethoxysilyl and the like. Examples also include those groups in which a hydrocarbon group is bound to an end of the silyl group of a trimethylsilyl group, a triethylsilyl methyl group, triphenylsilyl methyl group or the like.

The R¹ and R² may also be further substituted with a functional group which is inert to the reaction, for example, methoxy, cyano, dimethylamino, fluoro, chloro, hydroxy or the like.

Furthermore, R¹ and R² can be linked by chemical bonding to form a R¹-R² cyclic ring. The size of the ring is not particularly limited, but preferably the ring is formed of 5 to 30 atoms. Specific examples thereof include —(CH₂)₃—, —(CH₂)₄—, and the like, but are not limited to these.

Specific examples of these phosphorus compounds include (Rp)-isopropylmethyl phosphinate, (Sp)-isopropylmethyl phosphinate, (Rp)-menthylphenyl phosphinate, (Sp)-menthylphenyl phosphinate and the like, but are not limited to these.

The compound represented by the general formula: R³M (II) represents an organolithium or a Grignard reagent.

R³ represents the same substituents as those for R². M represents lithium or magnesium halide, MgX (X═Cl, Br or I).

Specific examples of these compounds include methyllithium, butyllithium, isopropyllithium, t-butyllithium, benzyllithium, phenyllithium, methylmagnesium halide (the halide represents chloride, bromide or iodide; hereinafter, the same), butylmagnesium halide, vinylmagnesium halide, phenylmagnesium halide, isopropylmagnesium halide, t-butylmagnesium halide, benzylmagnesium halide and the like, but are not limited to these.

R⁴X represented by the general formula (IV) represents an organic halide, while R⁴ represents the same substituents as those for R³.

In regard to the processes of the present invention, in the case where an optically active compound represented by the general formula (III) is obtained by reacting an optically active phosphorus compound represented by the general formula (I) with a compound represented by the general formula (II) and water, the ratio of use of the compound represented by the general formula (II) and water is not particularly limited, but it is usually preferable to set the ratio in the range of 1 to 10, in order to avoid racemization.

In regard to the processes of the present invention, in the case where an optically active compound represented by the general formula (V) is obtained by reacting an optically active phosphorus compound represented by the general formula (I) with a compound represented by the general formula (II) and a compound represented by the general formula (IV), the ratio of use of the compound represented by the general formula (II) and the compound represented by the general formula (IV) is not particularly limited, but it is usually preferable to set the ratio in the range of 1 to 10, in order to avoid racemization.

The reaction temperature of the present reaction processes is generally selected in the range from 0° C. or below to −100° C. or above to avoid racemization, but the reaction is preferably carried out at a temperature in the range of −5° C. to −85° C.

The solvent for the reactions is not particularly limited, and various solvents such as hydrocarbons, ethers, and esters can be used. Furthermore, these are used individually alone or as mixtures of two or more species.

Separation of the product from the reaction mixture is easily achieved by distillation or recrystallization.

### Examples

The present invention will be more specifically described based on the following Examples, but the present invention is not intended to be limited to these Examples.

### Example 1

(Rp)-menthyl phosphinate (1 millimole, 1 M pentane solution) was added dropwise to methyllithium (2 milliomoles, 2 M ether solution) which had been cooled to −80° C. After being stirred at −80° C. for 30 minutes, the reaction solution was heated to zero degree. The reaction solution was cooled again to −80° C., and then water (0.5 ML) was added thereto. The mixture was heated to room temperature, and extracted using hexane and chloroform, respectively. After drying and removal of the solvent, pure (Sp)-methylphenylphosphine oxide was obtained at a yield of 92%.

### Examples 2 to 16

Various reactions between an organolithium and a Grignard reagent were carried out in the same manner as in Example 1. The results are presented in Table 1 and Table 2.

TABLE 1

| | | | | Optical purity |
|---|---|---|---|---|
| Example | Reacting agent | Product | Yield (%) | (% ee) |
| 2 | i-PrLi | 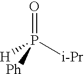 | 98 | 97 |
| 3 | n-BuLi | 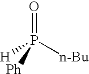 | 95 | 99 |
| 4 | t-BuLi | 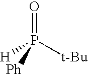 | 99 | 99 |
| 5 | Me₃SiCH₂Li | 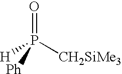 | 92 | 96 |
| 6 | MeMgI | 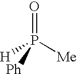 | 82 | 97 |
| 7 | n-BuMgBr | 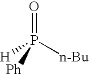 | 33 | 99 |
| 8 | n-BuMgI | 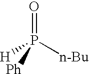 | 78 | 99 |
| 9 | CH₂═CHCH₂MgCl | 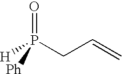 | 99 | 97 |
| 10 | CH₂═CHCH₂MgBr | 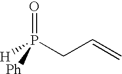 | 99 | 97 |
| 11 | 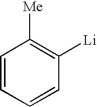 | 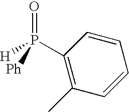 | 91 | 98 |

TABLE 2

| | | | | |
|---|---|---|---|---|
| | | | | Optical purity |
| Example | Reacting agent | Product | Yield (%) | (% ee) |

| | | | | |
|---|---|---|---|---|
| 12 | 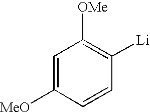 | 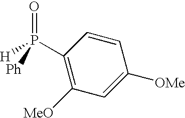 | 98 | 92 |
| 13 | 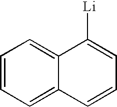 | 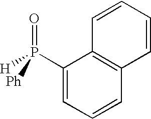 | 89 | 99 |
| 14 | 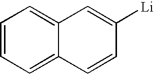 | 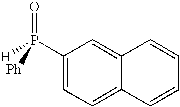 | 85 | 92 |
| 15 | 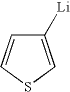 | 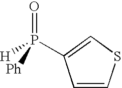 | 91 | 99 |
| 16 | 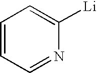 | 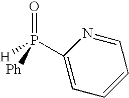 | 99 | 92 |

### Example 17

(Rp)-menthyl phosphinate (1 millimole, 1 M pentane solution) was added dropwise to butyllithium (2 millimoles, 1 M hexane solution) which had been cooled to −80° C. After stirring the reaction solution at −80° C. for 7 hours, iodomethane (3 millimoles) was added thereto, and the reaction solution was heated to zero degree. (Sp)-methylphenylbutylphosphine oxide was obtained at a yield of 84% (optical purity 93.3% ee).

### Example 18

Under the conditions of Example 1, allyl bromide was used instead of iodomethane, and (Rp)-allylmethylbutylphosphine oxide was obtained at a yield of 86% (optical purity 91% ee).

1. A process for producing an optically active phosphorus compound having an R- or S-type absolute configuration on phosphorus, represented by the general formula (III): 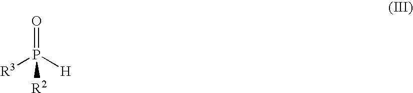
wherein R² represents hydrogen, an alkyl group, a cycloalkyl group, an aryl group, an aralkyl group, an alkenyl group, an alkoxy group, an aryloxy group, a heteroaryl group or a silyl-containing group; and R³ represents the same substituents as those for R²;
the process comprising reacting an optically active phosphorus compound having an R- or S-type absolute configuration on phosphorus, represented by the general formula (I): 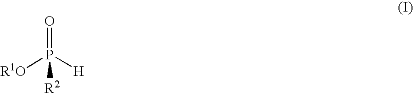
wherein R¹ represents a hydrogen atom, an alkyl group, a cycloalkyl group, an aryl group or an aralkyl group; and R² has the same meaning as defined above;
with water and a metal compound represented by the general formula: R³M (II), wherein R³ has the same meaning as defined above; and M represents lithium or magnesium halide, MgX (X═Cl, Br or I).

2. A process for producing an optically active phosphorus compound having an R- or S-type absolute configuration on phosphorus, represented by the general formula (V): 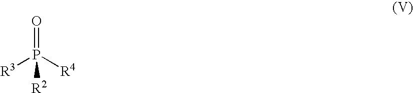
wherein R² and R³ have the same meanings as defined above; and R⁴ represents the same substituents as those for R³;
the process comprising reacting an optically active phosphorus compound having an R- or S-type absolute configuration on phosphorus, represented by the general formula (I): 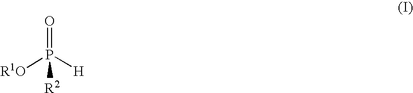
wherein R¹ and R² have the same meanings as defined above;
with a metal compound represented by the general formula (II):
R³M (II)
wherein R³ and M have the same meanings as defined above;
and a halide represented by the general formula (IV):
R⁴X (IV)
wherein R⁴ has the same meaning as defined above; and X represents halogen.

3. The process for producing an optically active phosphorus compound having an R- or S-type absolute configuration on phosphorus according to claim 1, wherein the optically active compound represented by the general formula (I) is (Rp)-menthylphenyl phosphinate.

4. The process for producing an optically active phosphorus compound having an R- or S-type absolute configuration on phosphorus according claim 1, wherein the reaction temperature is in the range of 0° C. to −100° C.

5. The process for producing an optically active phosphorus compound having an R- or S-type absolute configuration on phosphorus according to claim 2, wherein the optically active compound represented by the general formula (I) is (Rp)-menthylphenyl phosphinate.

6. The process for producing an optically active phosphorus compound having an R- or S-type absolute configuration on phosphorus according claim 2, wherein the reaction temperature is in the range of 0° C. to −100° C.

7. The process for producing an optically active phosphorus compound having an R- or S-type absolute configuration on phosphorus according claim 3, wherein the reaction temperature is in the range of 0° C. to −100° C.

8. The process for producing an optically active phosphorus compound having an R- or S-type absolute configuration on phosphorus according claim 5, wherein the reaction temperature is in the range of 0° C. to −100° C.
